(19) United States
(12) Patent Application Publication
(10) Pub. No.: US 2009/0266696 A1
(43) Pub. Date: Oct. 29, 2009

(54) SHEET-SWITCH MODULE

(75) Inventors: Isao MIYASHITA, Fujiyoshida-shi (JP); Kenshi Aihara, Fujiyoshida-shi (JP); Kaori Amano, Minamitsuru-gun (JP)

Correspondence Address: BROWDY AND NEIMARK, P.L.L.C.;624 NINTH STREET, NW, SUITE 300, WASHINGTON, DC, 20001-5303, US

(73) Assignee: CITIZEN ELECTRONICS CO., LTD., Fujiyoshida-shi (JP)

(21) Appl. No.: 12/430,959

(22) Filed: Apr. 28, 2009

(30) Foreign Application Priority Data
Apr. 28, 2008 (JP) 2008-116759

(51) Int. Cl. H01H 13/76

(52) U.S. Cl. 200/5 A

(57) ABSTRACT

A sheet-switch module includes a substrate; a plurality of switches formed on the substrate; a light guiding sheet disposed above the plurality of switches and having a plurality of protruding portions formed on a surface thereof facing each of the switches, each of the protruding portions being disposed to face a respective switch; and a light source disposed at one end of the substrate and causing light to enter the light guiding sheet, at least one of the plurality of protruding portions of the light guiding sheet having a light-shielding portion at a position of location of the at least one of the plurality of protruding portions. The light-shielding portion is configured by a light-shielding portion provided at least one of a peripheral surface and a peripheral edge of the protruding portions on an opposite side to a surface close to and facing the light source, or is configured by a light-shielding portion provided at a contact portion of the protruding portions and the switches.

### CROSS REFERENCE TO RELATED APPLICATIONS

This application is based on and claims the benefit of priority from prior Japanese Patent Application No. 2008-116759, filed on Apr. 28, 2008, the entire contents of which are incorporated herein by reference.

### BACKGROUND OF THE INVENTION

1. Field of the Invention

The present invention relates to a sheet-switch module that is provided at a key-input section in various kinds of electronic devices such as mobile phones and mobile information devices.

2. Description of the Related Art

Conventionally, a key input section provided on keypads of slim type electronic equipment such as mobile phones and mobile information terminal equipment has in many cases been configured using a sheet-switch module having an illumination function. One example of this kind of sheet-switch module is configured by a plurality of switches disposed on a substrate, a light guiding sheet disposed above the switches, and a light source disposed at one end of the light guiding sheet (Japanese Unexamined Patent Application Publication No. 2006-323843), (Japanese Unexamined Patent Application Publication No. 2006-324240), (Japanese Unexamined Patent Application Publication No. 2006-324241), (Japanese Unexamined Patent Application Publication No. 2006-324253), (Japanese Unexamined Utility Model Application Publication No. 7-1545).

Incidentally, in this kind of sheet-switch module, protrusions are provided on a back surface of the light guiding sheet corresponding to each of the switches, with an object of increasing the clicking sensation when the switches disposed on the substrate are pressed from above the light guiding sheet; however, there has been a problem that, if the protrusions are provided on the back surface of the light guiding sheet, there occurs a difference in brightness among the switches due to a difference in a light diffusion effect between the protrusions located at a position close to the light source and the protrusions located at a position far from the light source, and there occur variations in brightness between the switches when viewed from above the light guiding sheet.

Furthermore, there has been a problem that, even when viewing individual protrusions, a light reflection effect differs between a surface facing a light source side and a surface on an opposite side to the light source side, and consequently there is a conspicuous bright spotlighting of a portion of the protrusions, and an unevenness in brightness occurs even within a single switch.

### SUMMARY OF THE INVENTION

An object of the present invention is to provide a sheet-switch module that increases a clicking sensation when a switch is pressed from above a light guiding sheet, while at the same time suppresses an occurrence of a difference in brightness among a plurality of switches.

In order to achieve the above-described object, a sheet-switch module in accordance with an embodiment of the present invention includes a substrate; a plurality of switches formed on an upper surface of the substrate; a light-guiding sheet having an upper surface, a lower surface, and a peripheral edge surface between the upper surface and the lower surface, the light-guiding sheet disposed over the switches and the light-guiding sheet including a plurality of protruding portions on the lower surface at positions facing the switches; and at least one light source disposed on the upper surface of the substrate and facing the peripheral edge surface of the light guiding sheet, and at least one light-shielding portion provided at each of at least some of the protruding portions of the light-guiding sheet. The light-shielding portion is provided at a farther side from the light source of the each of the at least some of the protruding portions. Note that the light-shielding portion may be provided at a convex-peaks of the protruding portions.

The light-shielding portion may be a light-shielding portion provided at least one of a peripheral surface and a peripheral edge of the protruding portions on an opposite side to a surface close to and facing the light source, or is configured by a light-shielding portion provided at a contact portion of the protruding portions and the switches. The light-shielding portion may have one of the light-shielding portion provided at a periphery of the protruding portions and the light-shielding portion provided at the contact portion of the protruding portions and the switches, and the light-shielding portion may have both of the light-shielding portion provided at a periphery of the protruding portions and the light-shielding portion provided at the contact portion of the protruding portions and the switches.

Moreover, at positions of location of the protruding portions as seen in planar view, the light-shielding portion may be provided on an upper surface of the light guiding sheet, or between the light-guiding portion and the protruding portions of the light guiding sheet.

### BRIEF DESCRIPTION OF THE DRAWINGS

FIG. 1 is an exploded perspective view of a sheet-switch module in accordance with a first embodiment of the present invention.

FIG. 2 is a cross-sectional view of a switch portion of the above-mentioned sheet-switch module.

FIG. 3 is a perspective view of the switch portion in FIG. 2.

FIG. 4A is a cross-sectional view of a switch portion with a light-shielding portion provided on a convex portion at its periphery as a variation of the first embodiment.

FIG. 4B is a top plan view showing a shape of the switch portion in FIG. 4A.

FIG. 5 is a partial top plan view of the sheet-switch module with light-shielding portions provided.

FIG. 6 is a cross-sectional view of a switch portion with a light-shielding portion provided at a protruding portion of a light guiding sheet.

FIG. 7 is a cross-sectional view of a switch portion with a light-shielding portion provided at a contact portion of a protruding portion of a light guiding sheet and a switch.

FIG. 8 is a cross-sectional view of a switch portion of the sheet-switch module in accordance with a third embodiment that includes light-shielding portions each provided at a periphery of a protruding portion and at a contact portion to a switch.

FIG. 9 is a perspective view of the switch portion of the sheet-switch module in accordance with the third embodiment.

FIG. 10 is a partial top plan view of the sheet-switch module in accordance with the third embodiment.

FIG. 11 is a cross-sectional view of a switch portion showing another variation of the sheet-switch module in accordance with the third embodiment.

FIG. 12 is a cross-sectional view of a switch portion showing another variation of the sheet-switch module in accordance with the third embodiment.

### DETAILED DESCRIPTION OF THE PREFERRED EMBODIMENTS

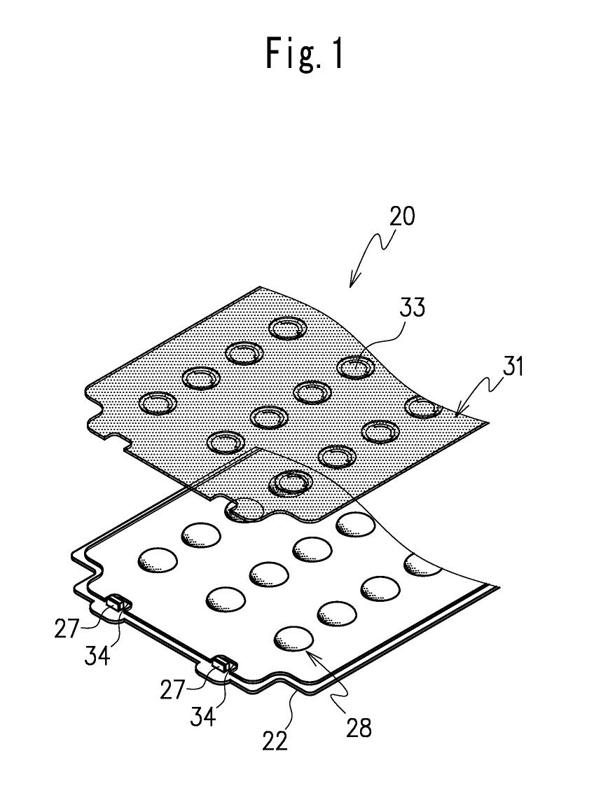

FIGS. 1 to 6 show a sheet-switch module 20 in accordance with a first embodiment of the present invention. The sheet-switch module 20 includes a substrate 22 provided with a plurality of switches 28 on an upper surface of the substrate 22, a light-guiding sheet 31 having an upper surface, a lower surface, and a peripheral edge surface between the upper surface and the lower surface and disposed over the switches 28 on the substrate 22, and at least one light source 27 disposed on the upper surface to face a peripheral portion or a peripheral edge of the light-guiding sheet 31. The light-guiding sheet 31 is provided with protruding portions 33 each of which faces each of the switches 28, and in the present invention at least one light-shielding portion is provided at each of at least some of the protruding portions 33 described hereafter. The light-shielding portions may be provided at all of the protruding portions 33 in accordance with conditions of light diffusions at the protruding portions 33.

The switches 28 are disposed on the substrate 22 at predetermined intervals. The substrate 22 may be a thinly formed epoxy resin board or a flexible printed circuit (FPC) board, and at least one light-emitting element 27 as a light source is disposed on an upper surface of the substrate 22 at a peripheral portion of the substrate 22 and a light-emitting surface of the light-emitting element 27 is disposed to face a peripheral portion or peripheral edge of the light-guiding sheet 31 to illuminate the whole of the switches 28. The switches 28 each of which includes a fixed contact 23 formed by pattern printing on the substrate 22 and a movable contact (spring contact) 24 disposed on the substrate 22 over the fixed contact 23. The spring contacts 24 may be fixed to the substrate 22 by a thin sheet material 25 provided with an adhesive on a back surface or lower surface side of the sheet material 25.

For example, a sheet-switch module used at a keypad of a mobile phone includes the substrate 22 formed in a substantially identical shape and size to the keypad, and a plurality of the switches 28 are provided at positions where numeric keys, alphabet keys, and other function keys of the keypad are disposed. The spring contacts 24 each formed in a dome shape from a thin metal material having elasticity to obtain a good clicking sensation when each of the switches is pressed. In addition, a mirror-like finish may be applied to upper surfaces of the spring contacts 24 to increase a reflectance of light, the light emitted from the light-emitting element 27 and guided through the light-guiding sheet 31.

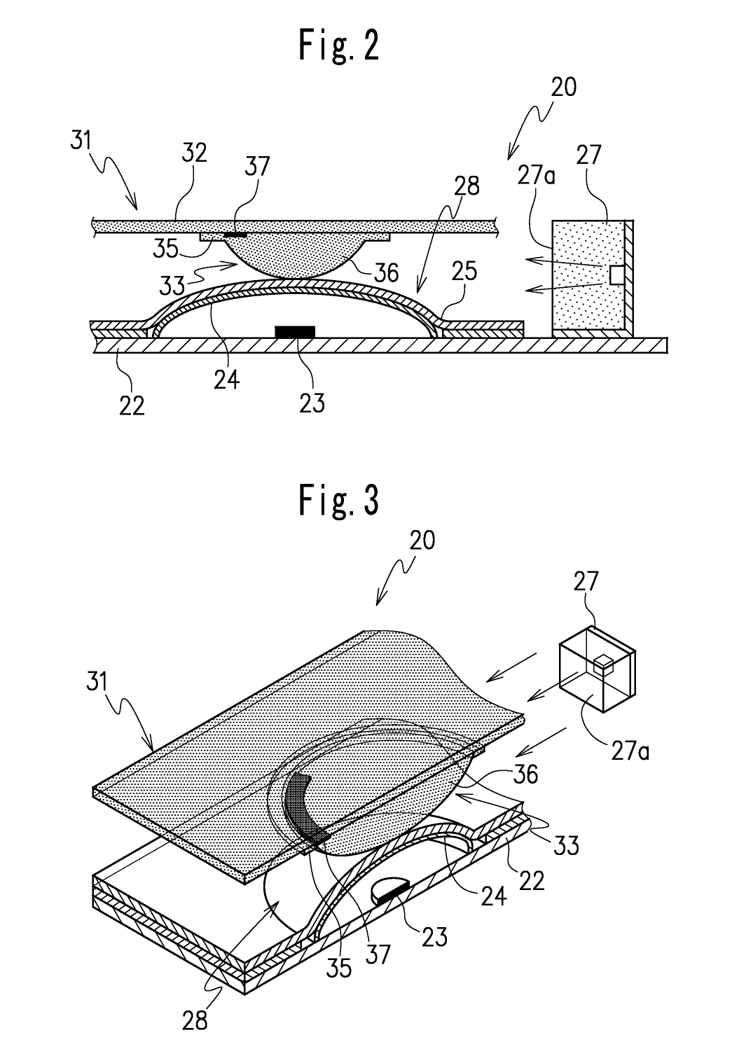

The sheet material 25 is provided with embossed portions at positions corresponding to positions where the spring contacts 24 are provided, and the sheet material 25 covers and holds the spring contacts 24 under embossed portions, as shown in FIG. 2. When the sheet-switch module 20 is manufactured, a transparent adhesive may be uniformly applied to an entire back surface or lower surface of the sheet material 25, and upper surfaces of the spring contacts 24 are adhered to the lower surface of the sheet material 25 at the embossed portions; subsequently, the sheet material 25 is placed on the upper surface of the substrate 22 over the fixed contact 23 disposed on the upper surface of the substrate 22, and adhered to the substrate 22. Note that it is also possible for the spring contacts 24 to be adhered directly to a sheet material 25 that is flat in shape without embossed portions on the lower surface of the sheet material 25 as described above, and for the sheet material 25 to be adhered and shaped along external shapes of the spring contacts 24 by heating and pressurization, for example.

In the present embodiment, a light-emitting diode to emit light in a lateral direction toward a peripheral portion or peripheral edge of the light-guiding sheet 31 is used as the light-emitting element 27. The light-emitting element 27 may be disposed at least one end portion of the upper surface of the substrate 22 and a light emitting surface 27a of the light-emitting element 27 is directed toward the peripheral portion or peripheral edge of the light-guiding sheet 31. Positions and number of light-emitting elements 27 are set according to a shape and size of the light-guiding sheet 31, the substrate 22, and a number of the switches 28 disposed. A sheet-switch module that is used at a rectangular-shaped keypad having numeric keys, function keys, for example, used in a mobile phone, light-emitting elements 27 may be disposed at equal intervals along one end or two opposite end portions of the substrate 22.

The light-guiding sheet 31 is a flat sheet-shaped member to transmit light, and may be transparent to semi-transparent. A light-guiding portion 32 is flat and has a substantially similar outline size to that of the substrate 22, and the protruding portions 33 are provided at positions in accordance with positions of the switches 28. The light-guiding portion 32 and the protruding portions 33 may be integrally formed. The protruding portions 33 are formed on the lower surface of the light-guiding sheet 31 and each of the protruding portions 33 faces each of the switches 28 to press a top of the switches 28 when the switch is pressed above the light-guiding sheet 31. Materials used for light-guiding portion 32 and the protruding portions 33 have a high light-transmitting capacity such as, for example, acrylic resin, silicone resin, polycarbonate resin, or polyethylene terephthalate resin. Note that there is no particular limitation on a thickness, but in consideration of light-guiding efficiency and characteristics of materials, the light-guiding sheet 31 is preferably formed with the thickness in a range of 0.05 mm to 0.2 mm.

As shown in FIG. 1, light-receiving notch portions or concave portions 34 each enclosing each of the light emitting elements 27 and the light emitting surfaces 27a are provided on a peripheral edge surface of the light-guiding sheet 31. The light-receiving portions 34 are formed as notch portions or concave portions at the peripheral edge surface of the light-guiding sheet 31. In addition, the protruding portions 33 each includes a ring-shaped fringe portion 35 that determines a range of a pressed contact area to the spring contact 24, and a convex portion 36 that is formed by adding layers in a convex shape within the fringe portion 35, as shown in FIG. 2. The fringe portions 35 and the convex portions 36 can be formed by screen printing a transparent resin, for example, and after the fringe portions 35 are formed by printing, the convex portions 36 are formed by adding layers by printing the transparent resin inside the fringe portions 35, respectively.

In the present invention, a light-shielding portion is provided at least some of the protruding portions 33. The light-shielding portion comprises a light-shielding portion 37 provided at a peripheral area of each of the protruding portions 33, and the light-shielding portion 37 provided at the peripheral area of the protruding portion 33 is disposed at a farther side from the light-emitting elements 27 of the protruding portion 33 or an opposite side to a closer side directly facing the light-emitting surfaces 27a of the light-emitting elements 27. The light-shielding portion 37 is formed in a circular arc shape along a part of a peripheral edge of the convex portion 36 and has a certain length and width along the peripheral edge or an inner peripheral edge of the fringe portion 35, as shown in FIG. 3. Here, the light-shielding portion 37 is provided between the lower surface of the light-guiding portion 32 and the protruding portion 33. The length and width of the light-shielding portion 37 is set according to positions of the switches in relation to received light amount from the light-emitting element 27, and the length of the light-shielding portion 37 along the peripheral edge of the convex portion 36 may be one half of or less than one half of an entire inner peripheral edge length of the fringe portion 35 or an entire peripheral edge length of the convex portion 36, and is preferably set to a level of approximately one quarter thereof. Furthermore, a range of the width that means the width extends in a perpendicular direction to the length of the light-shielding portion 37 is preferably one half of or less than one half of a radius of the convex portion 36 from the peripheral edge of the convex portion 36. In this embodiment, the width of the light-shielding portion 37 extends inside in a direction toward a center of the protruding portion 33. The light-shielding portions 37 are formed by printing black ink, preferably pale black ink, in advance at predetermined places on the lower surface of the light-guiding portion 32 before the protruding portions 33 are formed on the lower surface of the light-guiding portion 32. Note that the light-shielding portion 37 may also be formed straddling a part of the convex portion 36 and a part of the fringe portion 35.

In this way, by providing the light-shielding portion 37 along the peripheral edge of the convex portion 36 as seen in planar view, it is possible to suppress the unnecessary spotlight-like light diffusion effect at positions of the protruding portions 33 facing the switches 28, without blocking progress of light through the light-guiding portion 32 in a direction of arrows from the light-emitting element 27, as shown in FIG. 2. As a result, lowering of an efficiency of light guiding to other convex portions 36 provided on the light-guiding portion 32 can be suppressed, and light emitted from the light-emitting elements 27 can be uniformly guided to the entire light-guiding sheet 31.

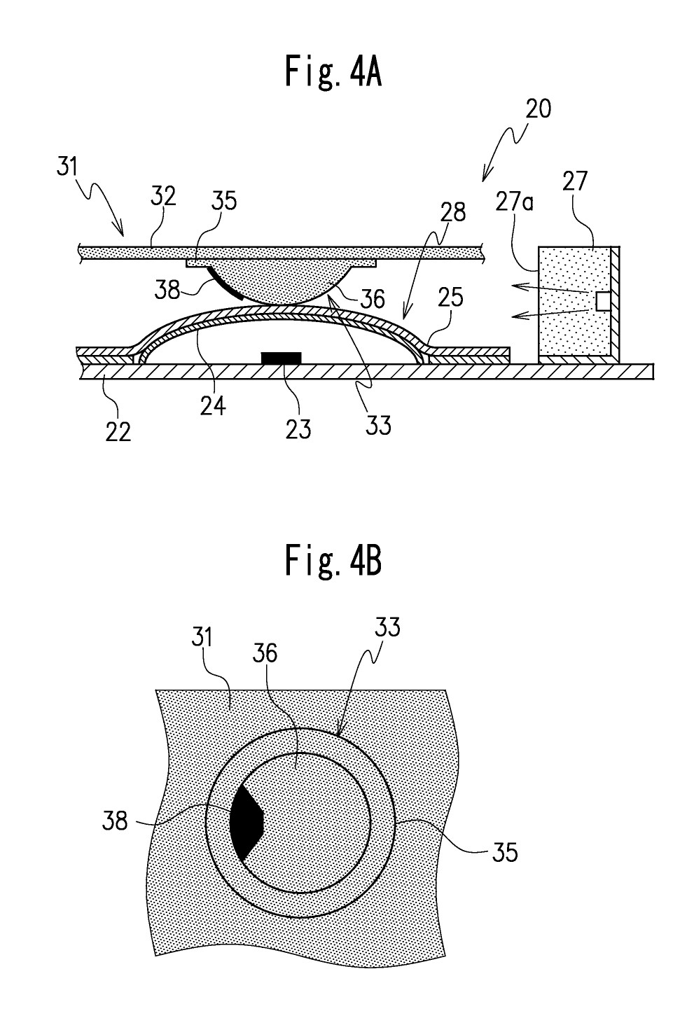

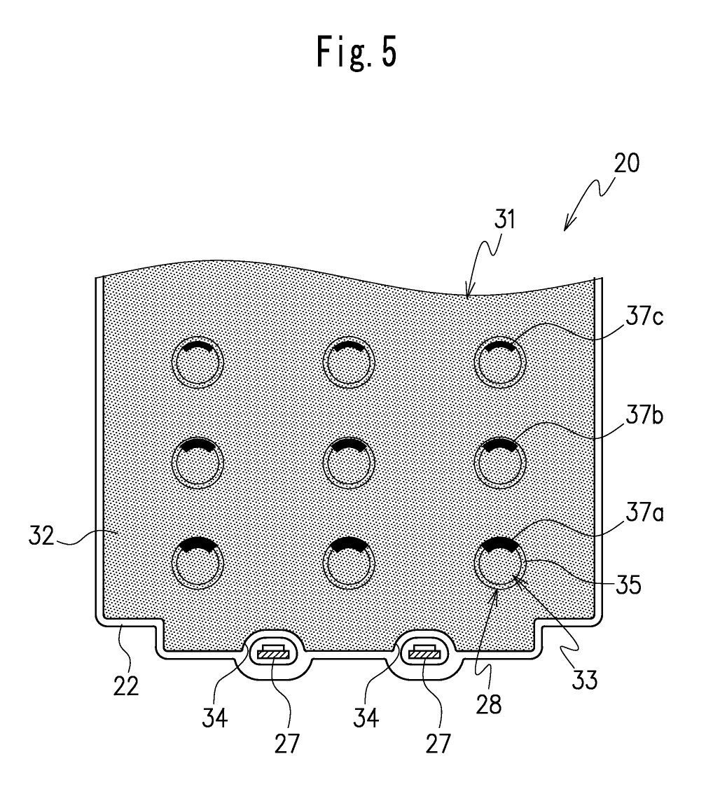

Besides being provided at a certain portion along the peripheral edge of the convex portion 36 as seen in planar view, the light-shielding portion may also be provided on a convex surface of the convex portion 36 at the farther side from the light emitting element 27 of the convex portion 36, as shown in FIGS. 4A and 4B. The light-shielding portion 38 is formed in a trapezoidal shape on the convex surface of the convex portion 36 from the peripheral edge of the convex portion 36 toward a convex-peak of the convex portion 36, as shown in FIG. 4B. An area of a trapezoid of each of the light-shielding portions 38 changes with distance from the light-emitting elements 27, similarly to the previously described light-shielding portion 37, but to curb spotlight-like light diffusion, the length of the base the trapezoid may be one half of or less than one half of an entire peripheral edge length of the convex portion 35, and is preferably set to a length of approximately one quarter thereof. Furthermore, a height of the trapezoid from the peripheral edge toward the convex-peak along the convex surface is preferably one half of or less than one half of the length from the peripheral edge of the convex portion 36 to the convex-peak of the convex portion 36. The light-shielding portion 38 formed in this way in a trapezoidal shape or fan shape along the convex surface. The base or a lower edge of the trapezoidal shape or fan shape is longer than an upper edge. Note that the light-shielding portions 38 are formed by printing pale black ink at predetermined places on the convex portions 36 after the protruding portions 33 have been formed on the lower surface of the light-guiding sheet 31.

FIG. 5 shows an example of a planar configuration of the sheet-switch module 20 in which the plurality of switches 28 are arranged at predetermined intervals. In the configuration in which the plurality of switches 28 are arranged on the upper surface of the substrate 22 and light-emitting elements 27 are disposed at one end of the substrate 22 in this way, the light diffusion effect is greater for the switches 28 on a side closer to the light-emitting elements 27 than for the switches 28 on a side farther from the light-emitting elements 27. Consequently, in the embodiment, a printing area of a light-shielding portion 37a of the protruding portions 33 disposed at a side closer to the light-emitting elements 27 is set larger, and, the printing area is gradually set smaller with distance from the light-emitting elements 27, such as light-shielding portions 37b and 37c. This is due to the fact that, the protruding portions 22 facing the switches 28 positioned distant from the light-emitting elements 27 receive light amount less than the protruding portions 22 positioned closer to the light-emitting elements 27. By gradually reducing the printing area of the light-shielding portions from 37a, and 37b, to 37c with distance from the light-emitting elements 27, it is possible to adjust a shielded light amount. As a result, a difference in brightness among the switches become less noticeable, and the switches of the entire sheet-switch module appeared to be uniformly illuminated.

In addition, it is also possible to set the printing area of the light-shielding portions 37 identical irrespective of a distance from the light emitting elements 27, and adjust the shielded light amount through a lightness/darkness of a printing density. That is to say, adjustment of a shielded light amount is possible also by darkening a black color printing density at the light-shielding portions 37a on a side closer to the light-emitting elements 27, and lightening the black color printing density, as a distance from the light emitting elements 27 gradually increases as with the light-shielding portions 37b and 37c, and the same operational effects can be obtained as previously described ways for adjusting. Note that this kind of adjustment of the shielded light amount by printing area and printing density is similar also for the light-shielding portion 38 provided on a peripheral surface of the convex portion 36 such as that shown in FIG. 4.

Further, positions of the light-shielding portions 37 and 38 need only to be provided at the farther side from the light-emitting elements 27 of each of the protruding portions 33; consequently, there is no need for all of the light-shielding portions 37a, 37b, and 37c to be formed regularly at identical corresponding positions of the each of the protruding portions 33 as shown in FIG. 5. For example, regarding the protruding portions 33 arranged at both of left and right ends of the light-guiding sheet 31 shown in FIG. 5, the arcs of the light-shielding portions 37 may be provided at left and right displaced positions along the peripheral edge of the convex portion 36 to intersect light emitted radially from the light-emitting elements 27. In this way, the light-shielding portions 37 and 38 can be appropriately set at places where light diffusion is most marked, in accordance with the reached light amount and positions from the light-emitting elements 27.

Next, a light-emitting operation of the sheet-switch module 20 according to the above-mentioned configuration is described on the basis of FIGS. 2 and 5. A current is supplied to the light-emitting elements 27 from a mother board or the like via a connector (not shown) provided on the substrate 22. Light emitted radially from the light-emitting surfaces 27a of the light-emitting elements 27 moves from the light-receiving portion 34 of the light-guiding portion 32 via the respective protruding portions 33 toward an opposite end portion of the one end where the light-emitting elements 27 are disposed. In such a light-guiding process, when the light emitted from the light-emitting element 27 passes above the respective protruding portions 33, there is an increase in light diffused upwardly by the protruding portions 33 provided on the lower surface of the light-guiding portion 32 and by the mirror-like finish of the upper surfaces of the spring contacts 24, and there is an increase in brightness of emitted light; however, on the other hand, there are also occurrences of spotlight-like reflection at regions of the protruding portions 33 at the opposite side farther from the one side where the light-emitting elements 27 are disposed. In the above-described embodiment, since light-shielding portions 37 printed with black ink are formed to match those regions where there is spotlight-like reflection, a light diffusion rate in the regions can be lowered and the light diffusion effect in each of the protruding portions 33 can be made uniform.

In addition, even if the light-shielding portion 37 is formed on the protruding portions 33, since the light-guiding portion 32 is substantially flat, light guided inside the light guiding sheet 31 from the light emitting element 27 is not blocked by the protruding portions 33, and can be guided in the light-guiding portion 32 to the opposite end portion of the one end where the light-emitting elements 27 are disposed without unevenness.

As previously described concerning the printing area and the printing density of the light-shielding portions 37 and 38, by adjusting a size of an area and a density according to a reflection state of light and so on, the brightness of emitted light and variations in emitted light in each of the protruding portions 33 can be appropriately adjusted.

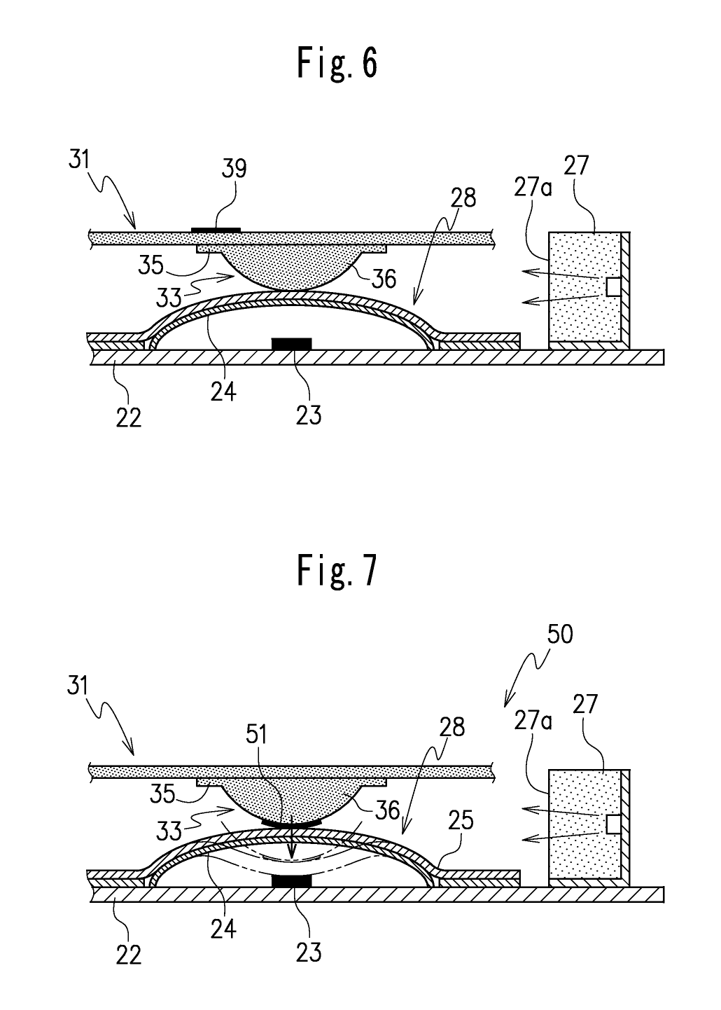

The light-shielding portion can be provided not only on the protruding portions 33 as shown in FIGS. 2 and 4, but a light-shielding portions 39 can be provided on the upper surface of the light-guiding sheet 31 as shown in FIG. 6. Even in this case, the light-shielding portion 39 is preferably formed in a curved shape along the inner peripheral edge of the surrounding portion 35 or the peripheral edge of the convex portion 36 of the protruding portion 33 as seen in planar view, similarly to the light-shielding portion 37 shown in FIG. 2. Even in the case that the light-shielding portion 39 is formed on an upper surface of the light guiding sheet 31 in this way, an operational effect is similar to that of the light-shielding portions 37 and 38 shown in FIGS. 2 and 4, and a spotlight-like reflected light in the protruding portions 33 can be suppressed. Moreover, in this case, the light-shielding portions 39 can be printed in either of processes before and after forming the protruding portion 33 on the light-guiding portion 32.

FIG. 7 shows a second embodiment of the sheet-switch module in accordance with the present invention. Hereafter, portions common to the first embodiment are described assigning identical symbols. A sheet-switch module 50 of the present embodiment has protruding portions 33 formed on the lower surface of a light guiding sheet 31 facing switches 28, and has a light-shielding portion (central light-shielding portion) 51 provided on a central portion of the protruding portions 33, more specifically on the convex-peak of each of the convex portions 36 of the protruding portions 33. The central light-shielding portion 51 is formed by printing, using pale black ink similar to that used for the previously described light-shielding portions. A range of printing in a normal state is centered on a top of the convex portion 36 that is in contact with a top of the switch 28 and has a circular shaped spread along a top surface of the convex portion 36 surrounding the top of the convex portion; in one example, the range of printing is set in a range that a spring contact 24 is bent in a curved shape when the light guiding sheet 31 is pressed from above and the spring contact 24 is in contact with a fixed contact 23, as shown in FIG. 7. By providing the central light-shielding portion 51, light diffusion at the convex-peak of the convex portion in contact with the switch 28 can be suppressed.

In addition, the central light-shielding portions 51 are preferably formed by a non-adhesive coating material. The coating material is a coat of a black ink including a fluorine-containing coat material, the fluorine-coat material is water-repellent and an abrasion-resistant, and the central light-shielding portion 51 can be formed by applying the coating material to a convex-peak of the protruding portion 33 that is in contact with the switch 28. Since the coating material has a non-adhesive quality, excessive bonding and adhesion to a contact surface between the convex-peak of the protruding portion 33 and the switch 28 can be prevented. As a result, a comfortable clicking sensation can be obtained continuously without any loss of springiness in the switch 28. By configuring the central light-shielding portion 51 by the non-adhesive coating material in this way, light diffusion at the protruding portion 33 can be suppressed, and, in addition, a switching operation of the switch 28 can be effected reliably and comfortably. Note that it is also possible to prepare the coating material separately from the black ink, and apply the fluorine-containing coat after printing the black ink on the convex-peaks.

Note that a similar operational effect can be obtained also in a case where the central light-shielding portion 51 is provided on a top of the switch 28 instead of on the convex-peak of the convex portion 36.

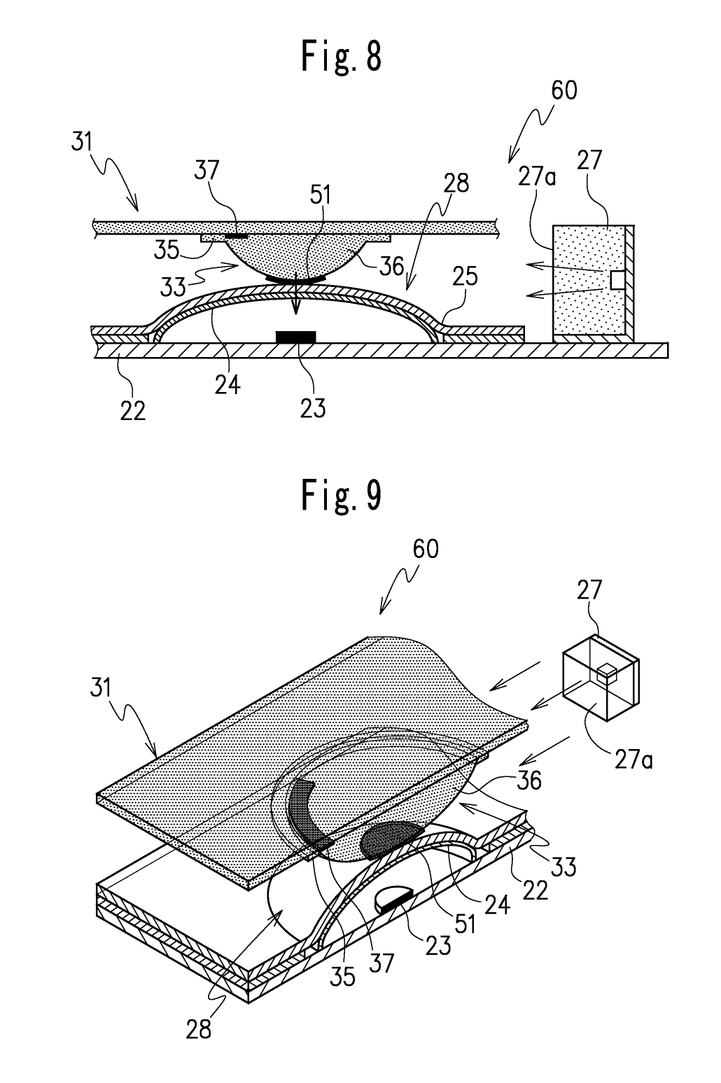

FIGS. 8 through 12 show a third embodiment of the sheet-switch module in accordance with the present invention. Hereafter, portions common to the first and second embodiments are described assigning identical symbols. A sheet-switch module 60 in accordance with the present embodiment has both the light-shielding portion 37 and the central light-shielding portion 51 provided on the protruding portions 33 formed on a back surface of a light guiding sheet 31 facing switches 28. That is to say, the light-shielding portion 37 is provided on a portion of a peripheral edge of a convex portion 36 of the protruding portions 33 on an opposite side to a surface facing a light emitting surface 27a of a light emitting element 27, similarly to the first embodiment, and the central light-shielding portion 51 is provided on a top of the light protruding portions 33, similarly to the second embodiment. In the embodiment, since providing the central light-shielding portion 51 makes it possible to suppress light diffusion in a portion that makes contact with the switch 28, a combined effect with a light-shielding portion 37 makes it possible to greatly reduce light diffusion in the protruding portions 33 in entirety.

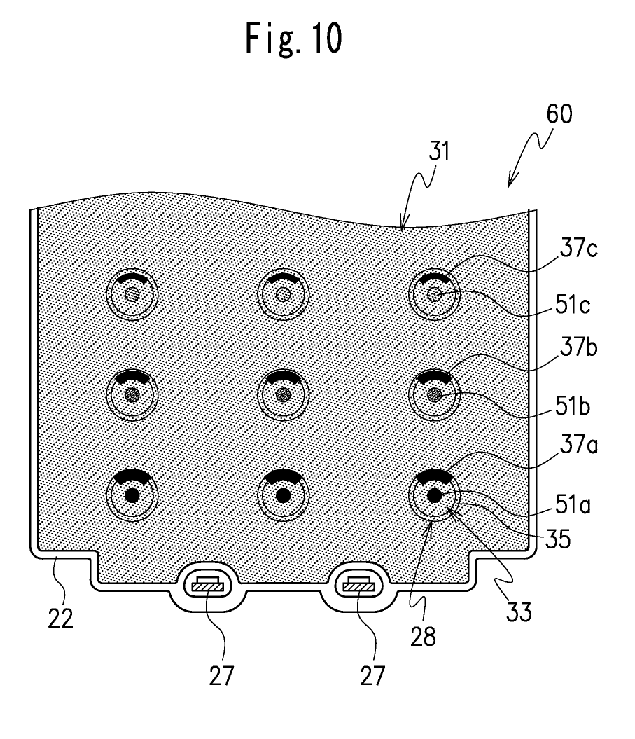

FIG. 10 shows an example of a planar configuration of the sheet-switch module 60 in accordance with the third embodiment. The sheet-switch module 60 has a configuration in which a plurality of switches 28, each of the switches 28 having a spring contact 24, are arranged on a substrate 22, a plurality of light emitting elements 27 being disposed at one end of the substrate 22. As described previously, a light diffusion effect is greater for the switches 28 on a side near to the light emitting elements 27 than for the switches 28 on a side far from the light emitting elements 27. Consequently, in this embodiment too, similarly to the previous embodiments, a printing area of a light-shielding portion 37a provided on the protruding portions 33 at a side near to the light emitting elements 27 is set large, and, as the protruding portions 33 become gradually more distant from the light emitting elements 27, the printing area is gradually set smaller, as with light-shielding portions 37b and 37c. Note that it is also possible to fix the printing area of the light-shielding portions 37a, 37b, and 37c, and adjust a shielded light amount through a lightness/darkness of a printing density.

Meanwhile, regarding central light-shielding portions 51, to obtain a good clicking sensation, a printing area of central light-shielding portions 51a, 51b, and 51c must be formed constant irrespective of a distance from the light emitting elements 27. Consequently, adjustment of a shielded light amount of the central light-shielding portions 51 is effected through a lightness/darkness of a printing density. That is to say, a black color printing density of the central light-shielding portion 51a provided on the protruding portions 33 on a side near to the light emitting elements 27 is set dark, and, as a distance from the light emitting elements 27 gradually increases, the black color printing density is lightened, as with the central light-shielding portions 51b and 51c.

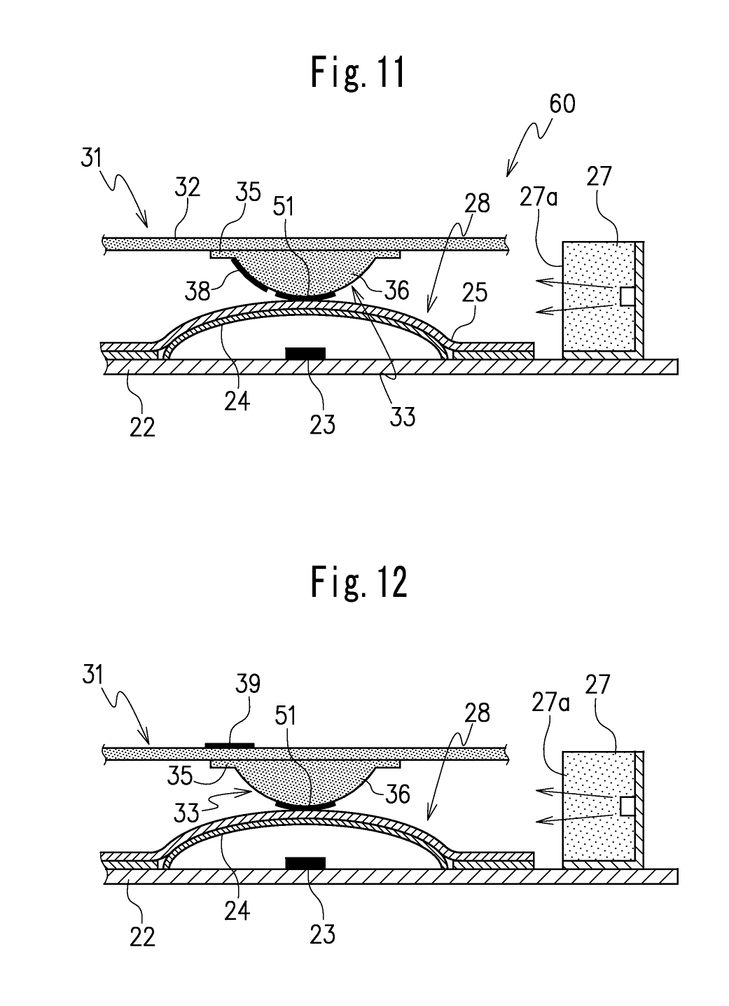

FIG. 11 shows an embodiment in a case of a configuration combining a light-shielding portion 38 provided on an outer surface of a convex portion of a protruding portion 33 and a central light-shielding portion 51, and FIG. 12 shows an embodiment in a case of a configuration combining a light-shielding portion 39 provided on an upper surface of a light guiding sheet 31 and a central light-shielding portion 51, respectively. In both embodiments, unevenness of emitted light due to light diffusion at both of central portions and peripheral portions of each of the switches 28 and the protruding portions 33 is suppressed, and the switches 28 can be caused to display emitted light with a uniform illumination.

Furthermore, both a light guiding plate of a thin plate form and a flexible pliant sheet can be used as the light guiding sheet of the present invention.

Moreover, in either of the above-mentioned first and second embodiments, by giving a mirror-like finish to an upper surface of a spring contact 24 where a sheet material 25 is adhered and providing a mirror surface portion to an entire upper surface, by applying an indented portion with a finely patterned indented finish, applying a textured finish, and so on, improvements in reflectance and improvements in brightness due to a light diffusion effect can also be striven for. Note that the spring contact 24 is not limited to a case of being formed by a metal material, and, for example, can also be formed by shaping a stretchable resin plate into spring contact-like domed shapes, forming an electrode electrically conducting with a fixed contact 23 on a back surface of the resin plate, and plating or vapor depositing a metal film for reflection on a front surface of the resin plate, by applying a paint including fine metal particles and glass particles having a light reflecting effect, and so on. By forming a region configuring a movable contact from a resin plate in this way, it is possible to obtain a soft clicking sensation different from previously described cases where the spring contact is entirely metal.

As described above, in the sheet-switch module in accordance with the present invention, a plurality of protruding portions are provided on a back surface of a light guiding sheet facing a plurality of switches disposed on a substrate, and the protruding portions are provided with a light-shielding portion; it is thus possible to illuminate with uniform brightness all of the switches disposed on the substrate and each individual switch, without any loss of a good clicking sensation when the switches are pressed from above the light guiding sheet.

The preferred embodiments of the present invention have been described, but it should be understood that the present invention is not limited to these embodiments and that various modifications and alterations may be made to the embodiments.

What is claimed is:

1. A sheet-switch module, comprising:
a substrate;
a plurality of switches disposed on an upper surface of the substrate;
a light-guiding sheet having an upper surface, a lower surface, and a peripheral edge surface between the upper surface and the lower surface, the light-guiding sheet disposed over the switches and the light-guiding sheet including a plurality of protruding portions on the lower surface at positions facing the switches; and
at least one light source disposed on the upper surface of the substrate and facing the peripheral edge surface of the light guiding sheet,
at least one light-shielding portion provided at each of at least some of the protruding portions of the light-guiding sheet.

2. The sheet-switch module according to claim 1,
wherein
the light-shielding portion is provided at a farther side from the light source of the each of the at least some of the protruding portions.

3. The sheet-switch module according to claim 2,
wherein
the protruding portions each include a convex portion, and the light-shielding portion is formed at the convex portion.

4. The sheet-switch module according to claim 3,
wherein
the light-shielding portion is provided at a position of a peripheral edge of the convex portion.

5. The sheet-switch module according to claim 4,
wherein
the light-shielding portion is formed in a band shape along the peripheral edge of the convex portion.

6. The sheet-switch module according to claim 3,
wherein
the light-shielding portion is provided along a convex surface of the convex portion.

7. The sheet-switch module according to claim 6,
wherein
the light-shielding portion has a trapezoidal shape narrowing toward a convex-peak of the convex portion.

8. The sheet-switch module according to claim 3,
wherein
the light-shielding portion disposed at a convex-peak of the convex portion.

9. The sheet-switch module according to claim 8,
wherein
the light-shielding portion is formed in a circular shape along the convex-peak of the convex portion.

10. The sheet-switch module according to claim 1,
wherein
the light-shielding portion is provided between the lower surface of the light-guiding sheet and the each of the at least some of the protruding portions.

11. The sheet-switch module according to claim 4,
wherein
the light-shielding portion is provided on the upper surface of the light-guiding sheet.

12. The sheet-switch module according to claim 8,
wherein
the light-shielding portion is formed by a non-adhesive coating material.

13. The sheet-switch module according to claim 8,
wherein
the light-shielding portion is provided on each of the switches facing the convex portion.

14. A sheet-switch module, comprising:
a substrate;
a plurality of switches disposed on an upper surface of the substrate;
a light-guiding sheet having an upper surface, a lower surface, and a peripheral edge surface between the upper surface and the lower surface, the light-guiding sheet disposed over the switches and the light-guiding sheet including a plurality of protruding portions, each of which includes a convex portion and a fringe portion, on the lower surface at positions facing the switches; and
at least one light source disposed on the upper surface of the substrate and facing the peripheral edge surface of the light-guiding sheet,
light-shielding portions provided at the protruding portions of the light-guiding sheet, the light-shielding portions each provided at a convex-peak of each of the convex portions and each provided at a farther side from the light source of each of the protruding portions.

15. The sheet-switch module according to claim 14,
wherein
an area of the light-shielding portion provided at the farther side from the light source of the each of the protruding portions decreases with distance from the light source.

16. The sheet-switch module according to claim 1,
wherein
an area of the at least one light-shielding portion provided at the each of the at least some of the protruding portions decreases with distance from the light source.

17. The sheet-switch module according to claim 15,
wherein
a printing density of the at least one light-shielding portion provided at the each of the at least some of the protruding portions decreases with distance from the light source.

18. The sheet-switch module according to claim 3,
wherein
a length of the light-shielding portion along a peripheral edge of the convex portion is one half of or less than one half of an entire peripheral edge length of the convex portion.

19. The sheet-switch module according to claim 3,
wherein
a width of the light-shielding portion in a perpendicular direction to a peripheral edge of the convex portion is approximately one half of or less than one half of a radius length of the convex portion.

20. The sheet-switch module according to claim 3,
wherein
a width of the light-shielding portion extending along a convex surface of the convex portion in a direction to a convex-peak is approximately one half of or less than one half of a length that is from a peripheral edge to the convex-peak of the convex portion.
